(19) United States
(12) Patent Application Publication
(10) Pub. No.: US 2017/0043913 A1
(43) Pub. Date: Feb. 16, 2017

(54) CONTAINER AND METHOD OF FORMING THE SAME

(71) Applicant: First Quality Packaging Solutions, LLC, Greak Neck, NY (US)

(72) Inventor: Mark Strachan, Jupiter, FL (US)

(21) Appl. No.: 15/235,966

(22) Filed: Aug. 12, 2016

Related U.S. Application Data
(60) Provisional application No. 62/204,324, filed on Aug. 12, 2015.

(51) Int. Cl. B65D 43/16; B29C 51/00; B29C 51/14; B29C 51/02; B65D 1/40; B29B 11/10

(52) U.S. Cl. CPC B65D 43/162; B65D 1/40; B29B 11/10; B29C 51/14; B29C 51/02; B29C 51/002; B29K 2023/12

(57) ABSTRACT

A one-piece container including a base and a lid. The base is made of a multi-layer sheet that includes an inner foamed layer and outer layers made of polypropylene. The inner foamed layer is made of industrial polypropylene regrind, pre and/or post consumer polypropylene regrind, recycled plastics or a combination of these materials. The lid is made of polypropylene.

### CROSS-REFERENCE TO RELATED APPLICATION

This application claims the benefit of U.S. Provisional Application Ser. No. 62/204,324, filed on Aug. 12, 2015, the entire contents of which are incorporated by reference herein.

### FIELD

This disclosure is related to containers, and more particularly to one-piece lidded containers.

### BACKGROUND

One-piece lidded containers (e.g., domed or clamshell containers) are commonly used in supermarkets and other food stores to package salads, pastries, prepared foods and the like. The containers are formed by thermoforming a length of thermoplastic material to provide a bottom tray having a container structure and top tray having a corresponding lid (e.g., dome) structure. The bottom and top trays are connected by a portion of the thermoplastic material that acts as a living hinge. The sheet of thermoplastic material from which the container is formed is preferably coextruded of transparent plastics to have generally transparent material in the regions defining the lid, with generally opaque material in the regions defining the base.

Ideally, the base of such containers should be thick enough so as to hold food before, during and after heating in a microwave, but the lid does not need to be as thick as the base because its primary function is merely to cover the base. However, due to the nature of the thermoforming equipment and process, the clear portions and opaque portions need to have the same thickness measurements. This results in a lid that is thicker than necessary for the corresponding base. The overly thick lid is disadvantageous in that it is wasteful of material, results in a heavier product, and in some cases may result in some difficulty in keeping the lid in the closed position.

### SUMMARY OF THE INVENTION

An object of the present invention is to provide a one-piece lidded container that includes a foamed base portion that is thicker than a lid portion, with the base portion being opaque and the lid portion being at least partially clear.

Another object of the present invention is to provide a method of manufacturing a one-piece container in which relative thickness of base and lid portions can be adjusted by drawing vacuum during a thermoforming process so that foamed material that makes up the base is made thicker.

A one-piece container according to an exemplary embodiment of the present invention comprises a base and a lid. The base is made of a multi-layer sheet that includes an inner foamed layer and outer layers made of polypropylene. The inner foamed layer is made of industrial polypropylene regrind, pre and/or post consumer polypropylene regrind, recycled plastics or a combination of these materials. The lid is made of polypropylene.

In other exemplary embodiments, the polypropylene used for the base and lid may be replaced or used in combination with APET (polyethylene terephthalate), HIPS (high impact polystyrene), PLA (polylactic acid), HDPE (high density polyethylene), LDPE (low density polyethylene) and other thermoformable plastics.

According to a process of making a one-piece container according to an exemplary embodiment of the present invention, a co-extrusion process is used to produce a film that includes a foamed portion and a non-foamed portion. The film is fed to a thermoforming tool where the film is formed into a container shape including a base made of the foamed portion of the film, a lid made of the non-foamed portion of the film and a hinge disposed between the base and the lid. The thermoforming tool includes a matched metal mold portion and another portion made up of a female mold portion and a plug assist element. The foamed portion of the film is fed into the matched metal mold portion and the non-foamed portion of the film is fed into the female mold/plug assist element portion of the thermoforming tool. Vacuum is drawn during the thermoforming process to adjust the thickness of the non-foamed portion, and preferably to make the base portion thicker than the lid portion. Pigment and/or coloring is added to the film resin so that the foamed base portion is opaque and the non-foamed lid portion is clear. In an exemplary embodiment, at least one portion of the lid portion also includes at least one opaque portion.

Other features and advantages of embodiments of the invention will become readily apparent from the following detailed description, the accompanying drawings and the appended claims.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1 is a block diagram of a container manufacturing system according to an exemplary embodiment of the present invention;

FIG. 2 is a cross-sectional view of a matched metal former according to an exemplary embodiment of the present invention;

FIG. 3 is a cross-sectional view of a container according to an exemplary embodiment of the present invention;

FIG. 4 is a representative cross-sectional view of the container of FIG. 4;

FIG. 5 is a bottom perspective view of a container according to an exemplary embodiment of the present invention;

FIGS. 6A-6I are cross-sectional views of a thermoforming tool during various stages of a thermoforming process according to an exemplary embodiment of the present invention; and

FIGS. 7A-7J are cross-sectional views of a thermoforming tool during various stages of a thermoforming process according to an exemplary embodiment of the present invention.

### DETAILED DESCRIPTION

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

Also, as used herein when referring to a container component, the term “clear” is intended to mean that container contents can be viewed through the component. Likewise, reference to a container component as being “opaque” means that container contents cannot be viewed through the component as a result of the component being colored or pigmented or due to crystallization of material used to form the component.

The present invention is directed to a clamshell container with a foamed polypropylene base and an non-foamed clear lid. The base is made from a three layers of polypropylene, with a central foamed polypropylene layer coextruded with external polypropylene layers. The lid is made from clear non-foamed polypropylene, although a portion may be opaque. As a result of using a non-foamed polypropylene, the lid is thinner than the base. Further, because it is foamed, the base provides some insulation from hot foods, increased strength and also requires less resin to produce.

According to an exemplary embodiment of making a clamshell container, chemically foamed polymeric materials are extruded using a flatsheet die, and the polymeric material is then molded into the shape of a container using a matched metal thermoforming process. The thermoforming process allows for adjustment of the sheet thickness by, for example, adjusting the closing distance between the matched metal molds and adjusting the amount of vacuum applied to the foamed sheet within the thermoforming apparatus. This allows for the production of a container having walls of varying thickness, such as, for example, a container with a lid that is thinner than its base.

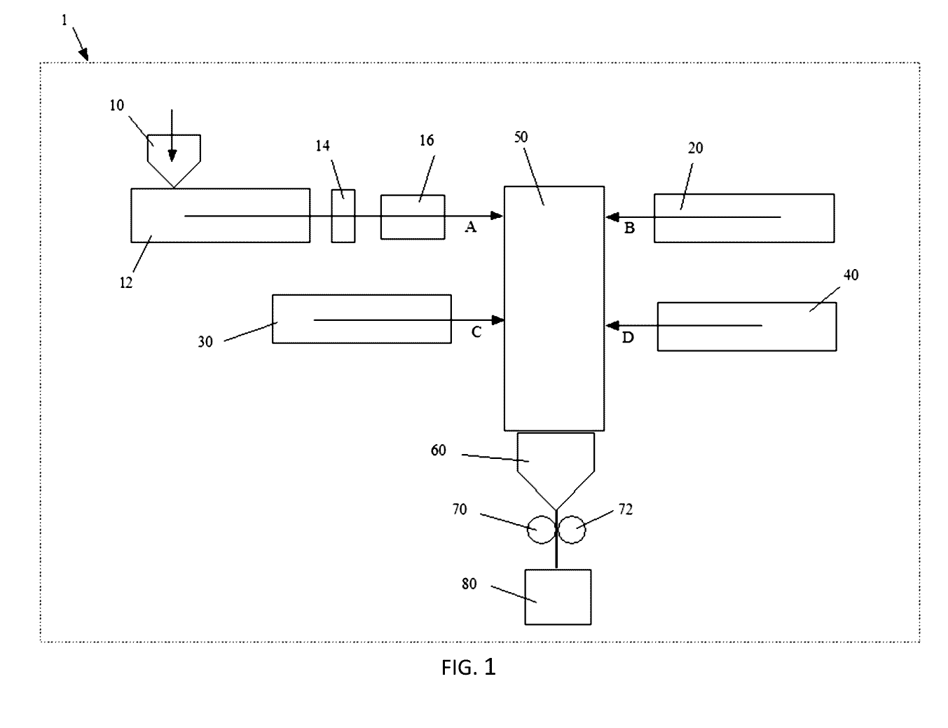

FIG. 1 is a block diagram of a container manufacturing system, generally designated by reference number 1, according to an exemplary embodiment of the present invention. The system 1 includes a main or first extruder 12, a second extruder 20, a third extruder 30, a fourth extruder 40, a feed block 50, flat sheet die 60, cooling rollers 70, 72 and thermoforming station 80. The first extruder 12 is preferably a twin screw extruder. Polypropylene regrind flake, virgin resin, a chemical blowing agent and a filler, such as, for example, talc or calcium carbonate, is blended and fed into the feed throat 10 of the first extruder 10. The blowing agent may be a hydrocarbon, such as, for example, nitrogen, carbon dioxide, propane or pentane. As shown by arrow A, the molten homogeneous blend from the main extruder 12 is fed through a screen changer 14, melt pump 16 and into a feedblock 50.

As shown by arrow B, second extruder 20 supplies the mixture for the lid of the container to the feedblock 50. This mixture includes polypropylene and an additive, such as, for example, a clarifier and an anti fog agent to provide a clearer lid.

Third extruder 30, also connected to the feedblock 50, provides a mixture (arrow C) of polypropylene and a black color additive. The flow of the molten blend from this extruder is diverted via the feedblock 50 to encapsulate the foamed blend of plastic coming from the main extruder 12.

Fourth extruder 40 may be added to apply a clear cap layer (arrow D) on both sides of the entire sheet structure (both black and clear portions). This helps to achieve a glossy look to the inner and outer portions of the final thermoformed part. When a filler such as talc or calcium carbonate is used, the black portion of the thermoformed part may appear chalky in appearance and suffer from a stress whitening defect. The clear cap layer on the outside eliminates this concern.

The feedblock 50 receives all the blended sources of molten plastics and layers them alongside or over one another to achieve the final sheet configuration. The feedblock 50 then directs these configured flows into the flat sheet die 60. The molten plastic from the flat sheet die 60 is then directed between two highly polished temperature controlled rollers 70, 72 which nip the plastic, with the gap between these rollers dictating the thickness of the sheet.

The nip roll gaps are set to the required thickness of the lid (clear portion of sheet) and because the black portion has an element of foaming within the core, it is compressed at the same nip roll. The sheet is then fed to the thermoforming station 80 that includes a thermoformer oven and thermoforming tool (explained in more detail below). Within the thermoformer oven, the black portion of the sheet containing the foaming agent and some percentage of compressed bubbles begins expanding while the clear non foamed portion does not expand. When the sheet is moved into the forming tool, the matched metal portion of the forming tool, which has vacuum on both sides of the mold, causes the black foamed portion to expand even further (dictated by closing gap setting in the mold). The clear side of the mold does not have a matched metal configuration, but instead has a female cavity mold (aluminum) only (i.e., no matching male mold). The clear side of the mold may have a fixed or an independently moving plug assist (composite), that pushes or pre-stretches the clear sheet down towards the female mold cavity. Vacuum on the female mold side is then turned on, which draws the clear sheet down to the surface of the cooled mold. The timing between when the vacuum is turned on in relation to the position of the plug assist in the mold cavity allows the operator to dial in the final thickness distribution of the clear plastic portion of the part (lid). Soon after (only on the clear side) an air pressure valve is actuated to channel compressed air at 50 to 100 psi against the pre-formed clear sheet, pushing it firmly against the female mold cavity, causing exceptional definition of the part. The form air pressure and vacuum is turned off and the plug assist retracted. Both mold halves are moved apart and the formed party foamed container is moved to a trim station, while a new forming cycle is started.

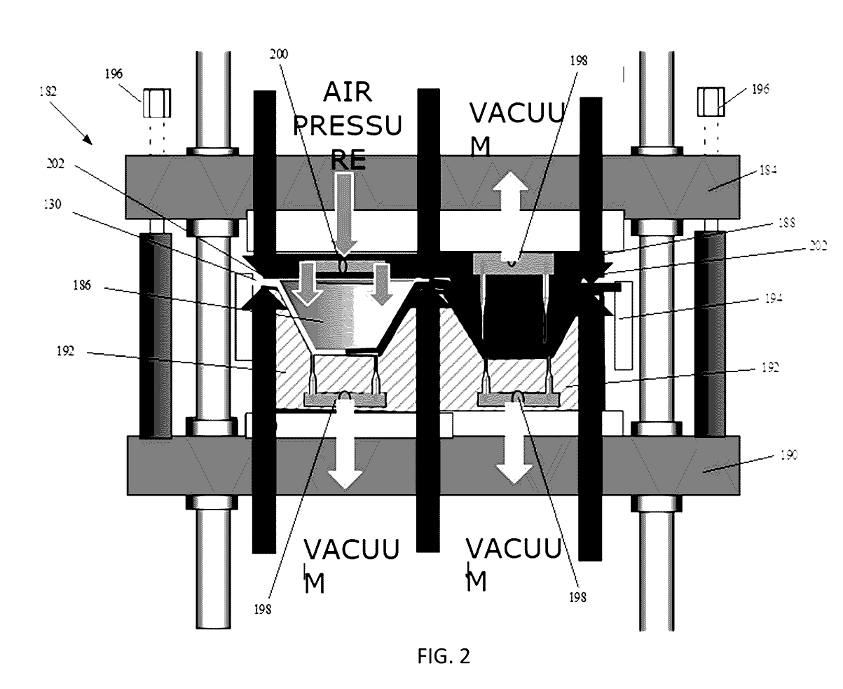

FIG. 2 is a cross-sectional view of a thermoforming tool 182 according to an exemplary embodiment of the present invention. The thermoforming tool 182 includes an upper platen 184, a plug 186, a positive mold part 188, a lower platen 190, negative mold parts 192, a sheet transport system 194 and adjustable platen closing stops 196. The positive mold part 188, negative mold parts 192 and plug 186 may be made of a metal material, such as, for example, aluminum.

In operation, the thermoplastic film 130 is fed into the thermoforming tool 182 by the sheet transport system 194 so that the foamed and opaque portion of the thermoplastic film 130 is positioned between the positive mold part 188 and a corresponding negative mold part 192 and the non-foamed and at least partially clear portion of the thermoplastic film 130 is positioned between the plug 186 and a corresponding negative mold part 192. The upper and lower platens 184, 190 are then moved towards one another by operation of corresponding actuators (not shown) so that the foamed and opaque portion of the thermoplastic film 130 is formed into a base of a clamshell container by the positive mold part 188 and a corresponding negative mold part 192 and the non-foamed and at least partially clear portion of the thermoplastic film 130 is formed into the lid portion of the clamshell container by the plug 186 and a corresponding negative mold part 192. The thickness of the finished container can be set by the platen closing stops 196 which adjust the closing distance of the upper and lower platens 184, 190.

The negative mold parts 192 and the positive mold part 188 each include a vacuum port 198 through which vacuum is drawn out of the mold cavity. The plug 186 has a shape that is similar to that of the positive mold part 188, but does not include a vacuum port. The plug 186 is moved independently of the upper platen 184 so that the plug 186 is able to pre-stretch the thermoplastic film 130 into the mold cavity. By application of vacuum through the vacuum port 198, the thermoplastic film 130 is then pulled into contact with the negative mold part 192 so that the non-foamed and at least partially clear lid of the container can be made thinner than the foamed and opaque base. Air pressure is then applied through the air pressure port 200 to further press the non-foamed and at least partially clear lid portion of the container onto the negative mold part 192. Meanwhile, application of vacuum to the top and bottom of the foamed and opaque portion of the thermoplastic film 130 results in increased size of the bubbles within the foam and hence an increase in overall thickness of the resulting container base.

The thermoformer 182 also includes coiners 202 that operate under sufficient tonnage to coin the base and lid flanges and the hinge portion of the container. As known in the art, the object of coining is to apply sufficient pressure to a part so that the part plastically deforms into the shape of the mold. In this case, the coining of the flanges also results in concealment of the foam within the container base. The coiners 202 also allow for improved accuracy in controlling thickness of the flanges.

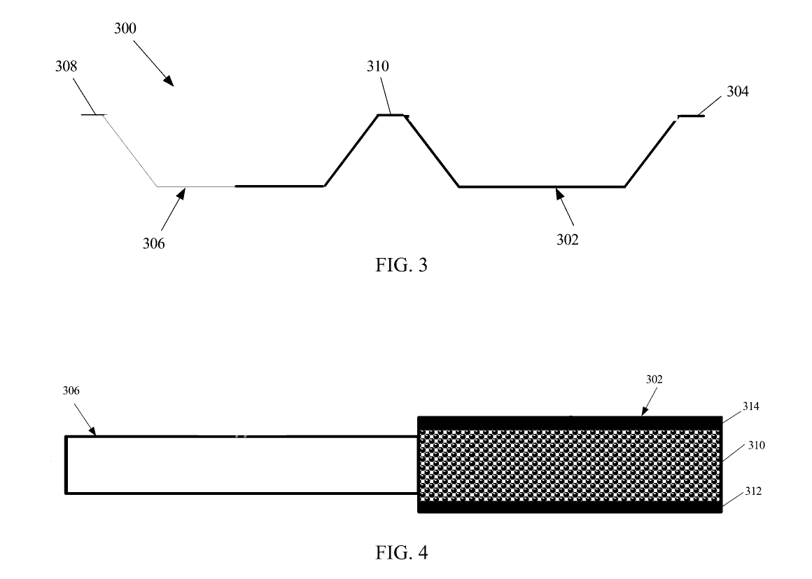

FIG. 3 is a cross-sectional view of a container, generally designated by reference number 300, and FIG. 4 is a bottom perspective view of the container 300 according to an exemplary embodiment of the present invention. The container 300 includes a base portion 302 including a flange 304, a lid portion 306 including a flange 308 and a hinge portion 310 disposed between the base portion 302 and the lid portion 306. The lid portion 306 includes vent holes 312 for releasing heat and vapor from inside the container 300. In FIG. 3, the darker portion of the cross section indicates that the material is opaque, as opposed to the lighter portion which indicates clear material. The opaque material extends into the lid portion 306 so that the lid portion 306 is not entirely clear. An object of the partially opaque nature of the lid portion 306 is to reduce UV degradation of food items held within the container. The opaque portion may extend approximately half way into the lid portion 306. The lid portion 306 may fold relative to the hinge portion 310 so that the lid portion 306 can be pressed onto the base portion 302 and held in position by a friction fit.

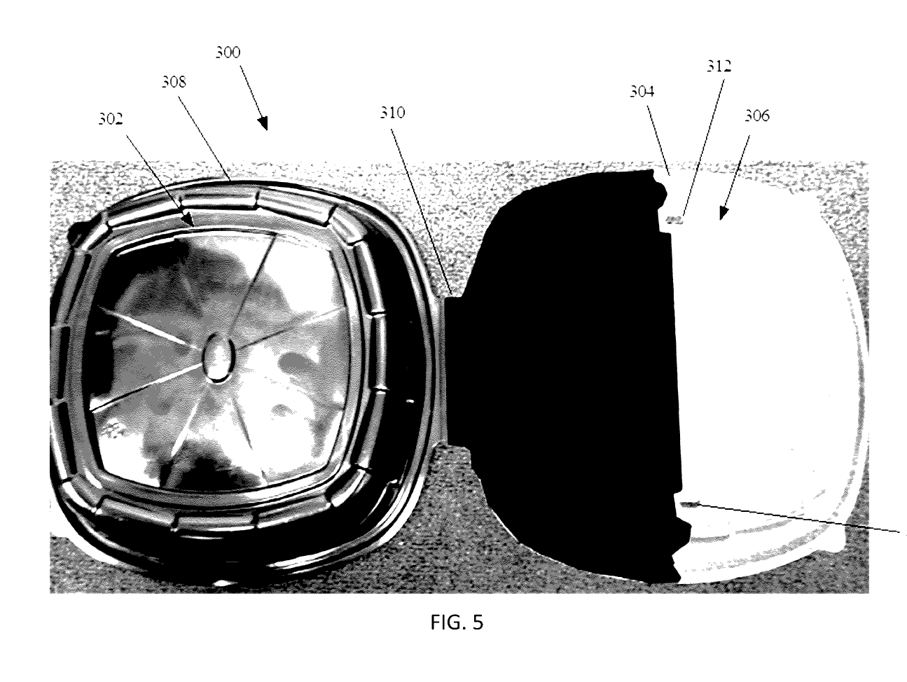

FIG. 5 is a representative view of the container 300 showing a more detailed cross section of the base and lid portions 302, 306 according to an exemplary embodiment of the present invention. The lid portion 306 is made of a single layer sheet of polypropylene and may have a thickness of, for example, 0.02 inches. The base portion 302 is made of a multi-layer sheet including an internal foamed layer 310 and external layers 312, 314 made of virgin polypropylene. The external layers 312, 314 include color or pigment, such as black or red coloring, to make the base portion 302 opaque. The internal foamed layer 310 may be made of, for example, pre and/or post consumer polypropylene regrind or a combination of polypropylene regrind and commingled plastics. The base portion 302 may have a thickness of, for example, 0.03 inches. The thickness of the internal foamed layer 310 may take up 80% to 90% of the entire thickness of the base portion 302, with the remaining thickness taken up by the external layers 312, 314.

In an exemplary embodiment of the invention, nucleating agents, such as, for example, beta nucleating agents, may be added to at least the polypropylene resin used to form the base portion 302. As known in the art, such nucleating agents are added to polypropylene to increase rate of crystallization for faster cycles and improved stiffness, strength and clarity. For example, a high beta crystallized polypropylene sheet is disclosed in U.S. Pat. No. 7,407,699, the contents of which are incorporated herein by reference in their entirety. Also, beta nucleation in this case may be used to provide a microwave-safe container, although it should be appreciated that polypropylene is already microwaveable without nucleation or foaming. Also, in exemplary embodiments, a mineral filler may be added to the material used to form the container.

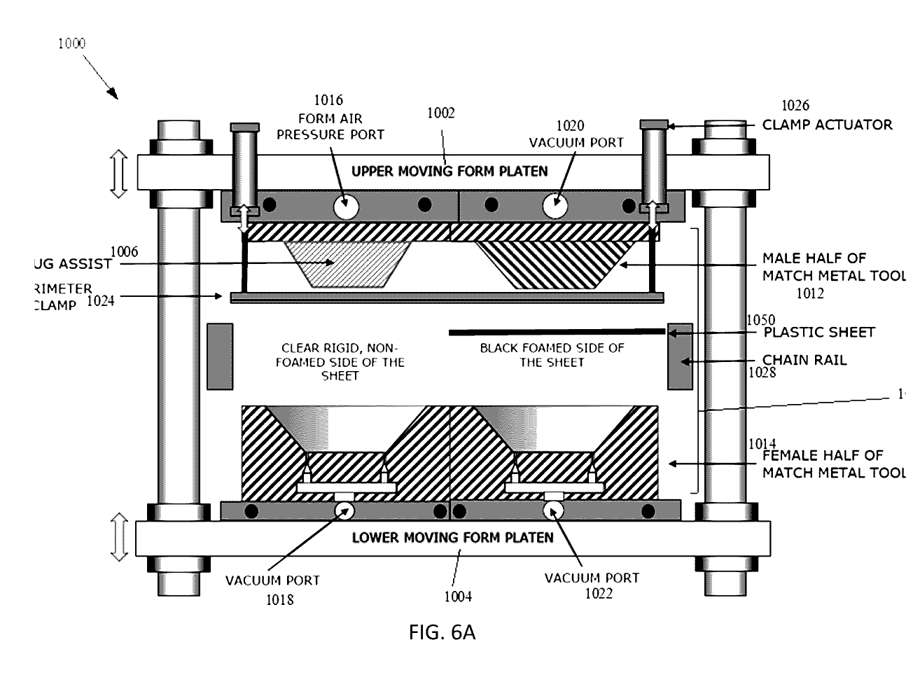

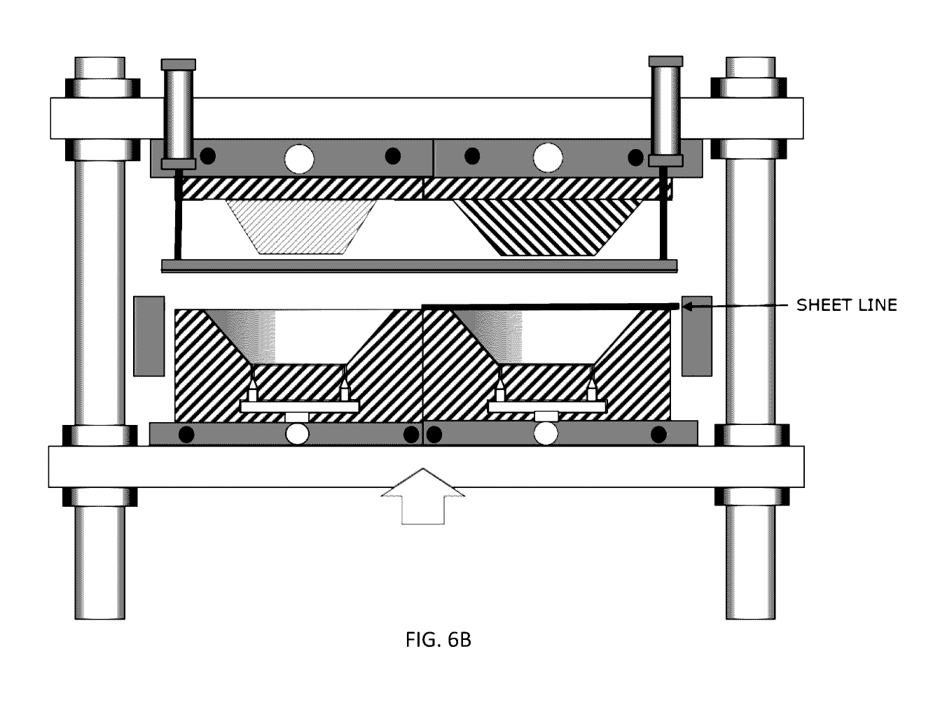

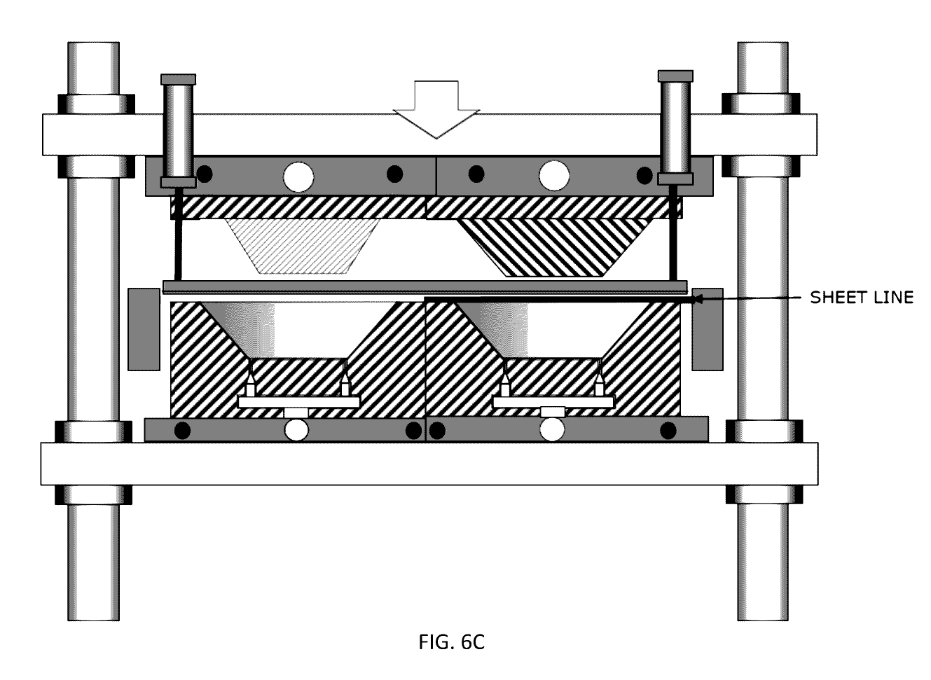

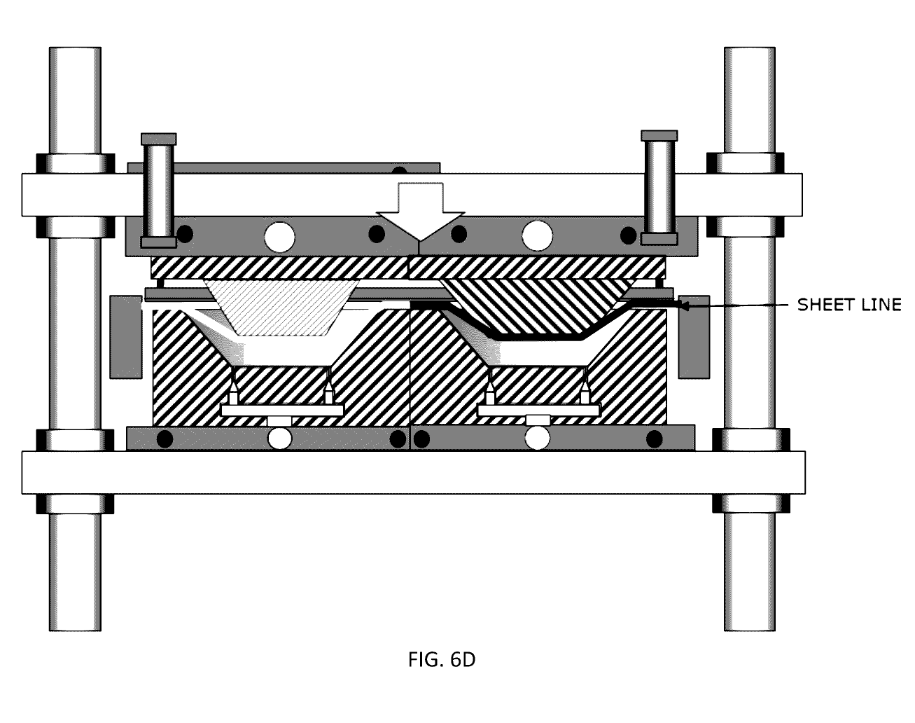

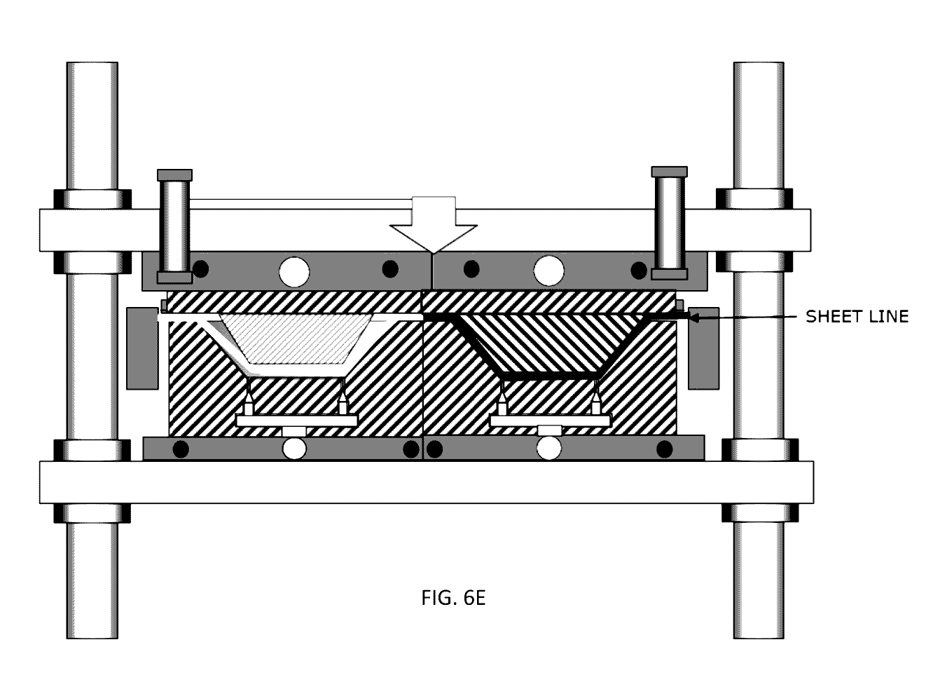

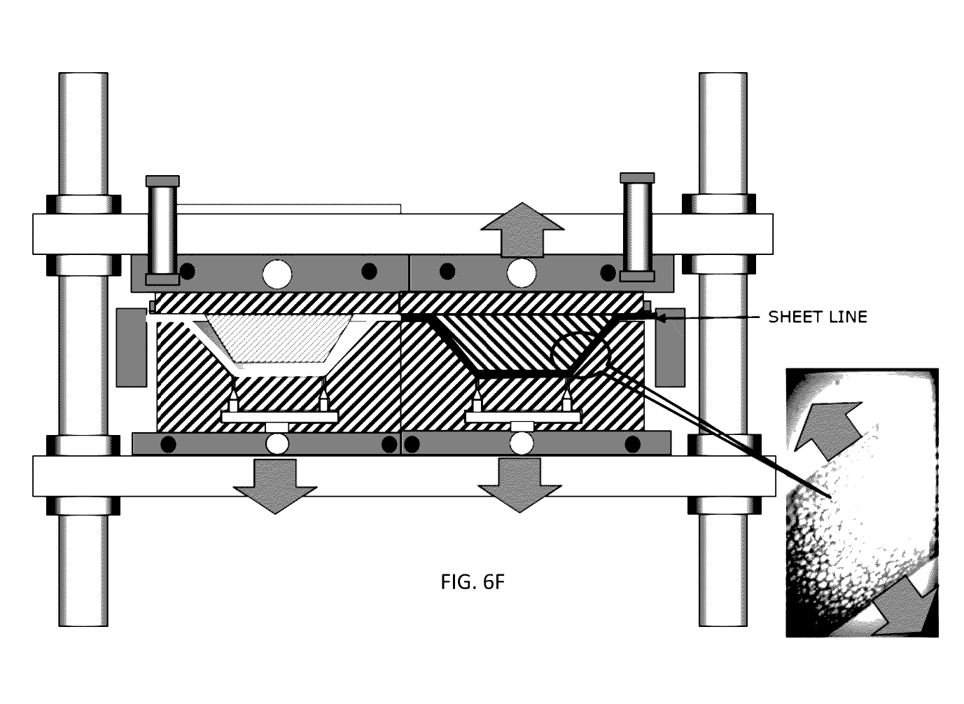

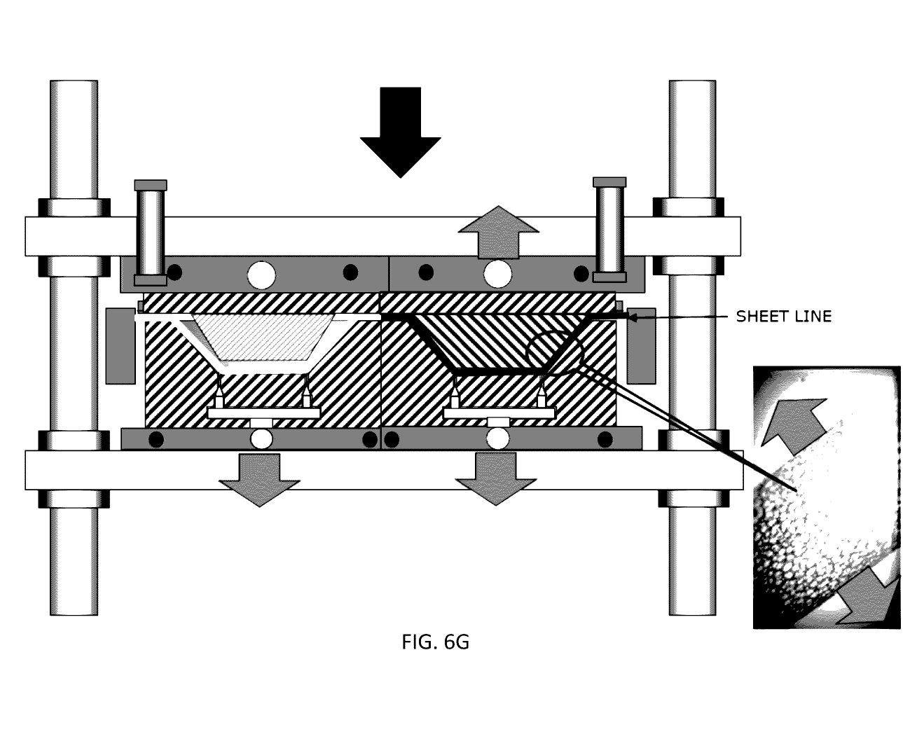

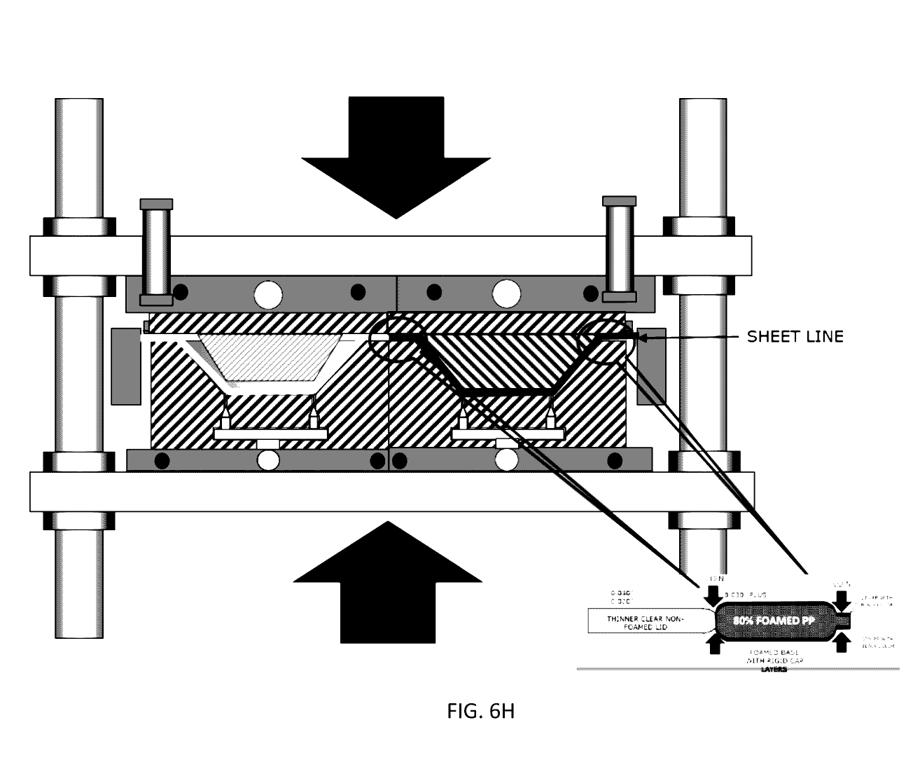

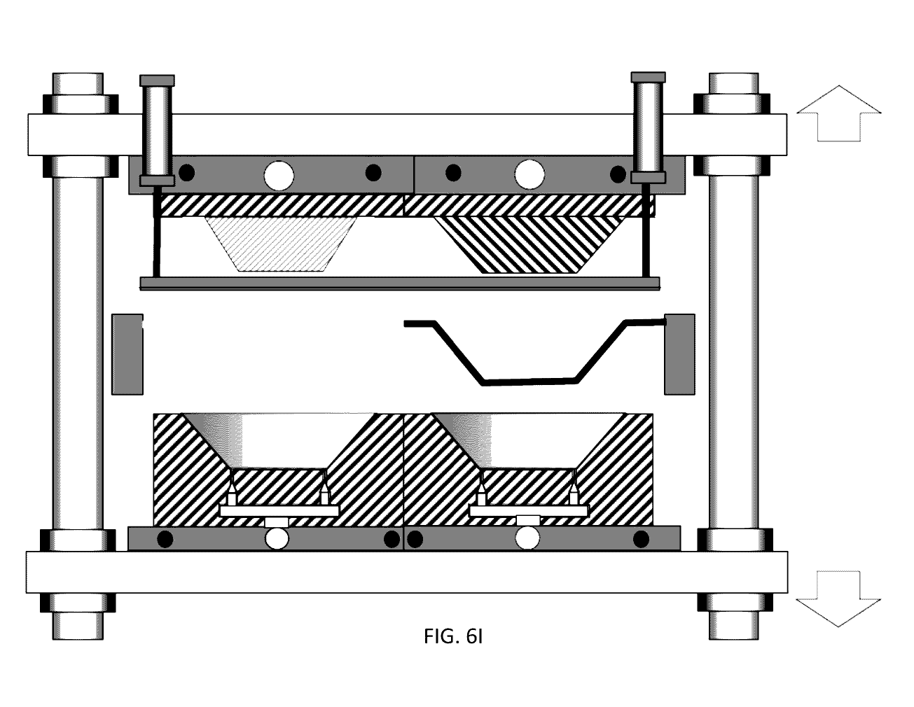

FIGS. 6A-6I are cross-sectional views of a thermoforming tool, generally designated by reference number 1000, during various stages of a thermoforming process according to an exemplary embodiment of the present invention. The thermoforming tool 1000 includes an upper form platen 1002, a lower form platen 1004, a plug assist element 1006, negative mold part 1008, a matched metal tool 1010 that includes a positive mold half 1012 and a negative mold half 1014, a form air pressure port 1016 associated with the plug assist element 1006, a vacuum port 1018 associated with the negative mold part 1008, a vacuum port 1020 associated with the positive mold half 1012 of the matched metal tool 1010, a vacuum port 1022 associated with the negative mold half 1014 of the matched metal tool 1010, a sheet clamp 1024 and a clamp actuator 1026. In operation, as shown in FIG. 5A, a heated thermoplastic film sheet 1050 is guided into the thermoforming tool 1000 by, for example, chain rails 1028. The sheet 1050 includes a clear and non-foamed side that is fed between the plug assist element 1006 and the negative mold part 1008 and an opaque and foamed side that is fed between the positive and negative mold halves 1012, 1014 of the matched metal tool 1010.

Then, as shown in FIG. 6B, the lower form platen 1004 is moved upwards so that the negative mold part 1008 and the negative mold half 1014 are in turn moved to the sheet line.

As shown in FIG. 6C, the upper form platen 1002 then moves the sheet clamp 1024 to the sheet line where the sheet clamp 1024 is activated by the clamp actuator 1026, resulting in the sheet 1050 being clamped firmly around the perimeter of each mold cavity.

As shown in FIG. 6D, the upper form platen 1002 continues to move the plug assist element 1006 and the positive mold half 1012 into their respective mold cavities, causing the sheet 1050 to be pre-stretched into the cavities. Due to the shape and type of material used for the plug assist element 1006, the effect of pre-stretching on the clear side is not the same as that on the opaque side where a temperature controlled aluminum positive mold is used. In this regard, the temperature of the two matched metal mold halves 1012, 1014 for the foamed base may be kept at the same temperature as the negative mold part 1008 on the non-foamed lid side. For example, the temperature for these components may be kept at approximately 80° F. In an exemplary embodiment, the plug assist is made of syntactic foam, Delrin® (available from DuPont of Wilmington, Del., USA), or aluminum.

As shown in FIG. 6E, the upper form platen 1002 continues to move downwards until the plug assist element 1006 is closed tightly with the negative mold part 1008 and the positive mold half 1012 is closed tightly with the negative mold half 1014. At this stage, the clear and non-foamed portion of the sheet 1050 is still only held against the plug assist element 1006, while the foamed portion of the sheet 1050 has a slight clearance between the positive and negative mold halves 1012, 104.

As shown in FIG. 6F, the vacuum port 1018 is then turned on to pull the non-foamed portion of the sheet 1050 off the plug assist element 1006 and against the negative mold part 1008. The vacuum ports 1020 and 1022 are also turned on, which causes the foam cells in the foamed portion of the sheet 1050 to expand, which in turn results in the sheet thickness within the foamed portion to increase upon release of the mold halves 1012, 1014.

As shown in FIG. 6G, a high form air pressure is then introduced through the form air pressure port 1016 to force the non-foamed portion of the sheet 1050 against the cooled negative mold part 1008. This ensures superior definition of the formed part and also helps cool the part efficiently as the sheet 1050 is held intimately against the surface of the negative mold part 1008.

As shown in FIG. 6H, the mold halves 1012, 1014 are then squeezed very tightly together to coin the perimeter of the foamed portion of the film 1050 so that the foamed inner core of the sheet 1050 is encased in a rigid outer layer of plastic.

As shown in FIG. 6I, the vacuum and air pressure is then turned off and the thermoforming tool 1000 is opened for removal of the formed part. The formed part may then be moved to a trimming station for further processing.

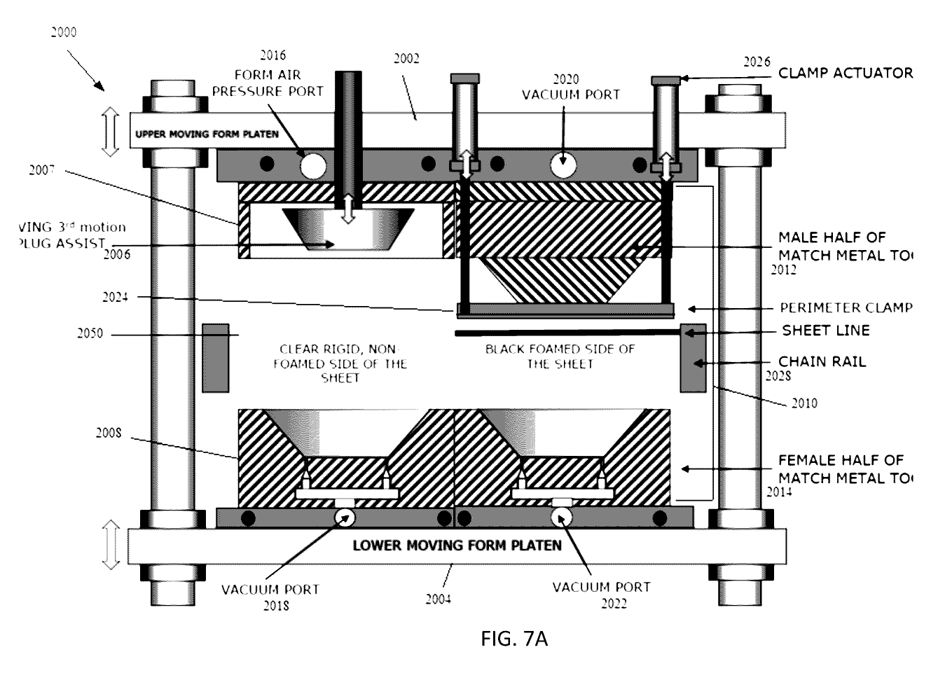

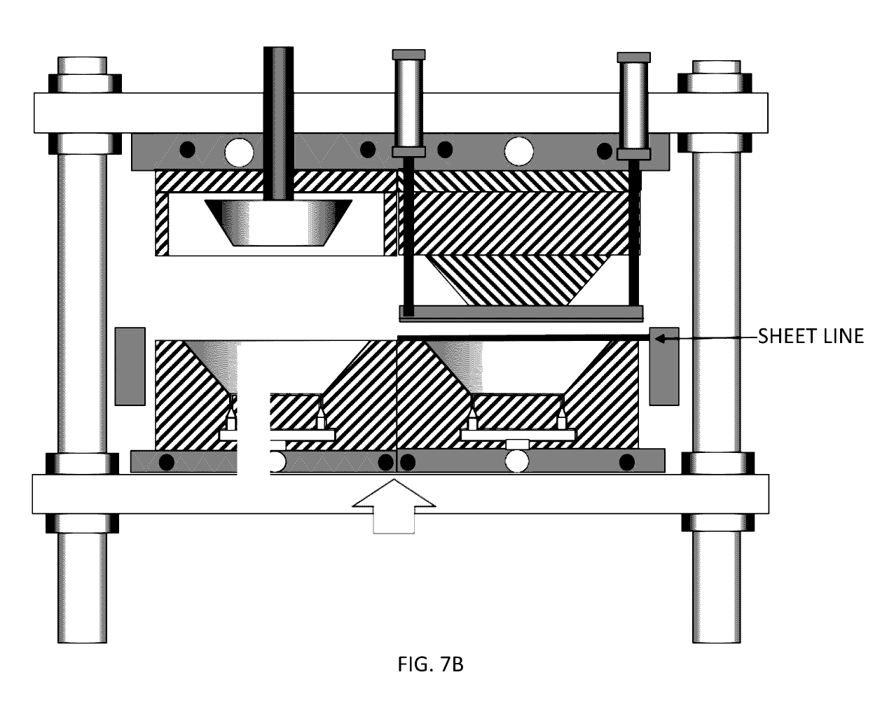

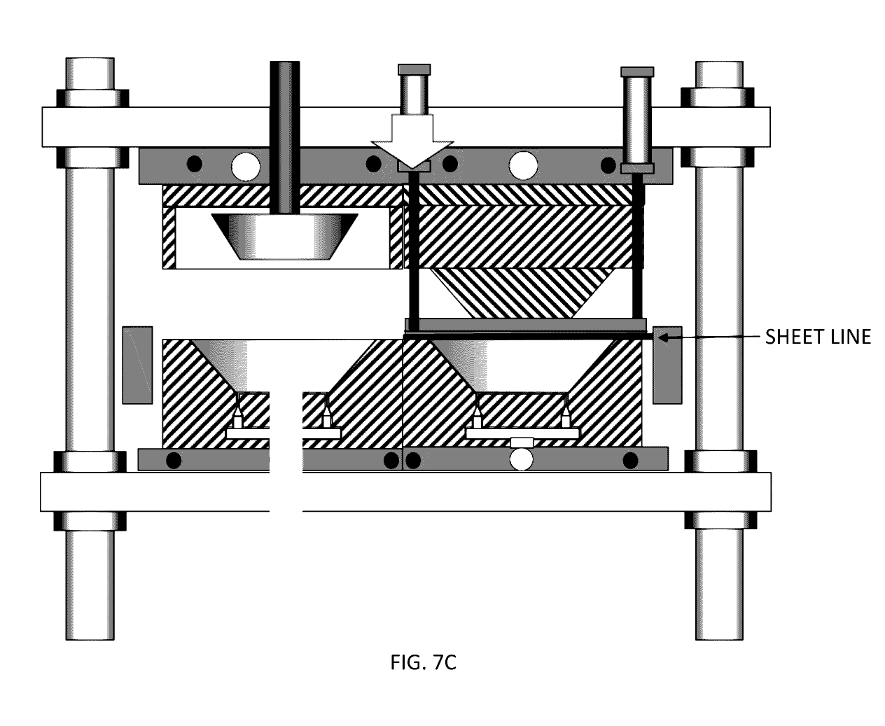

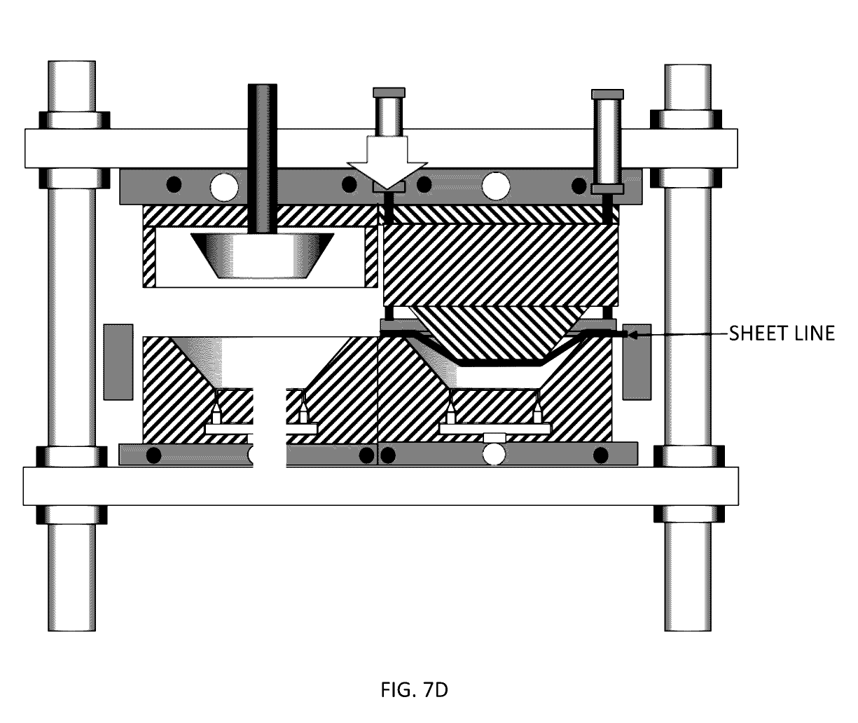

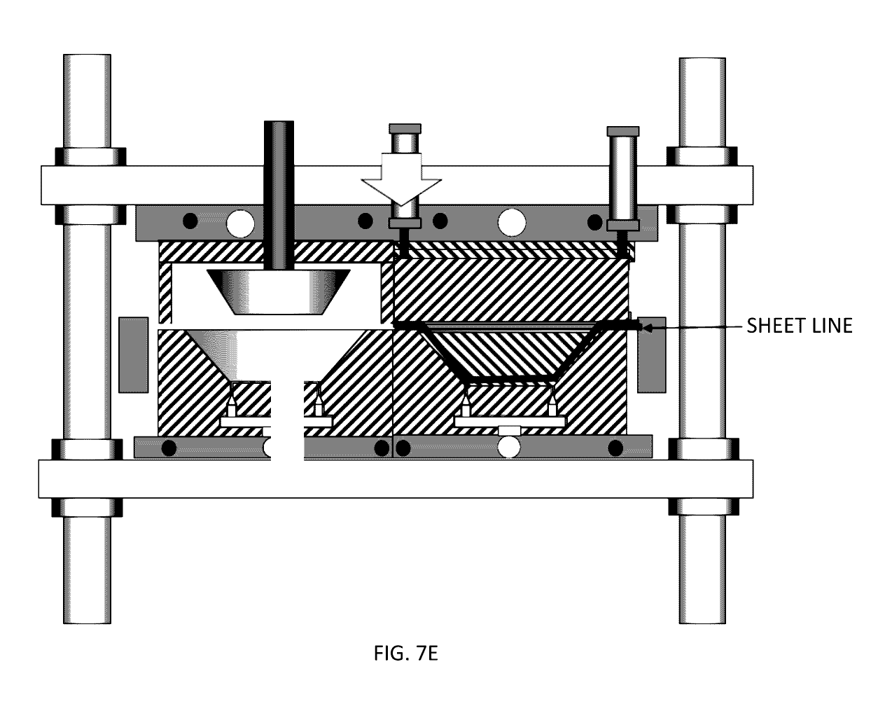

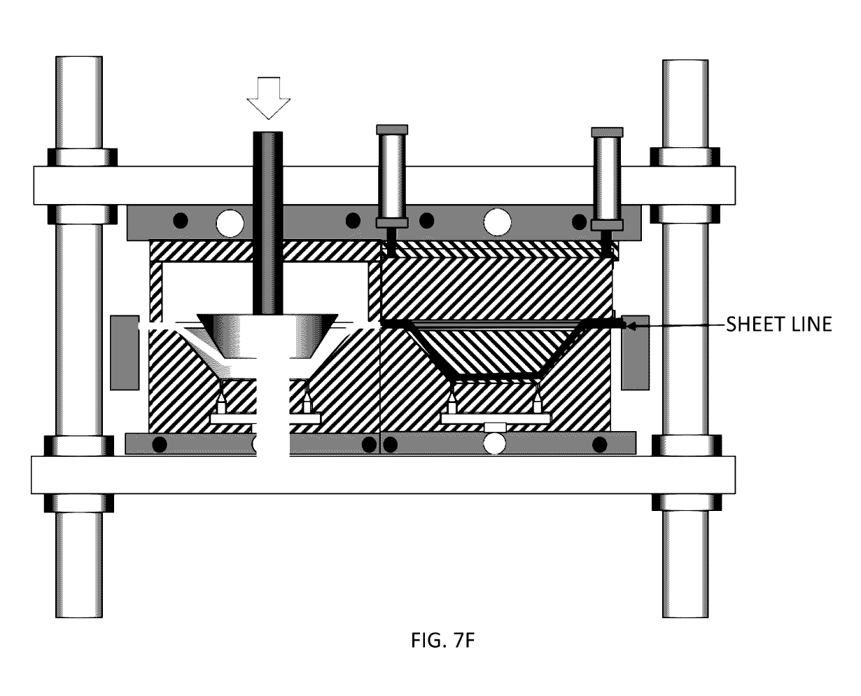

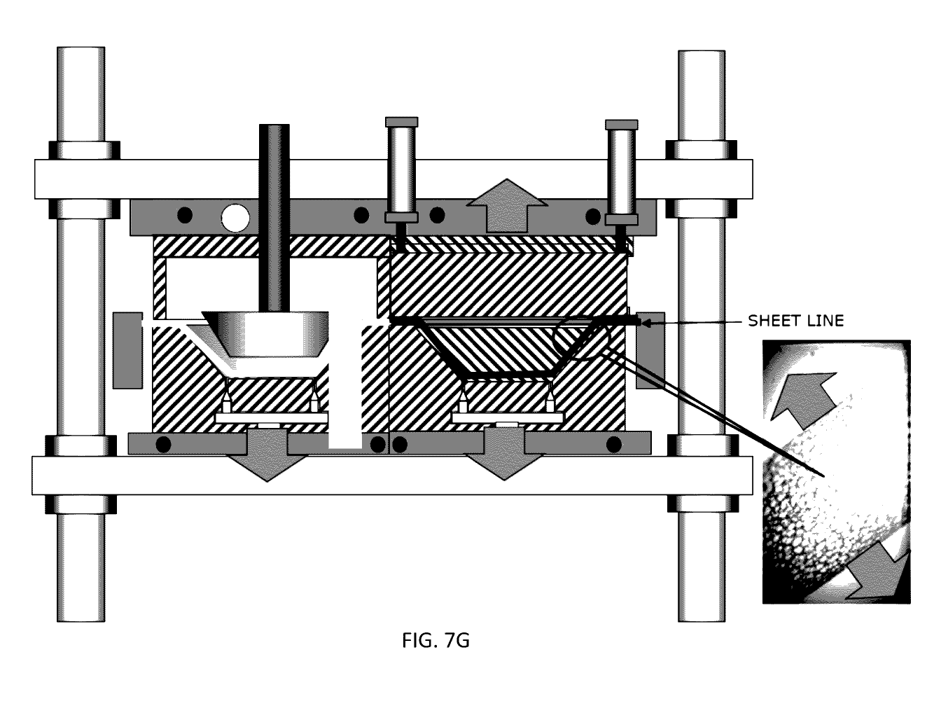

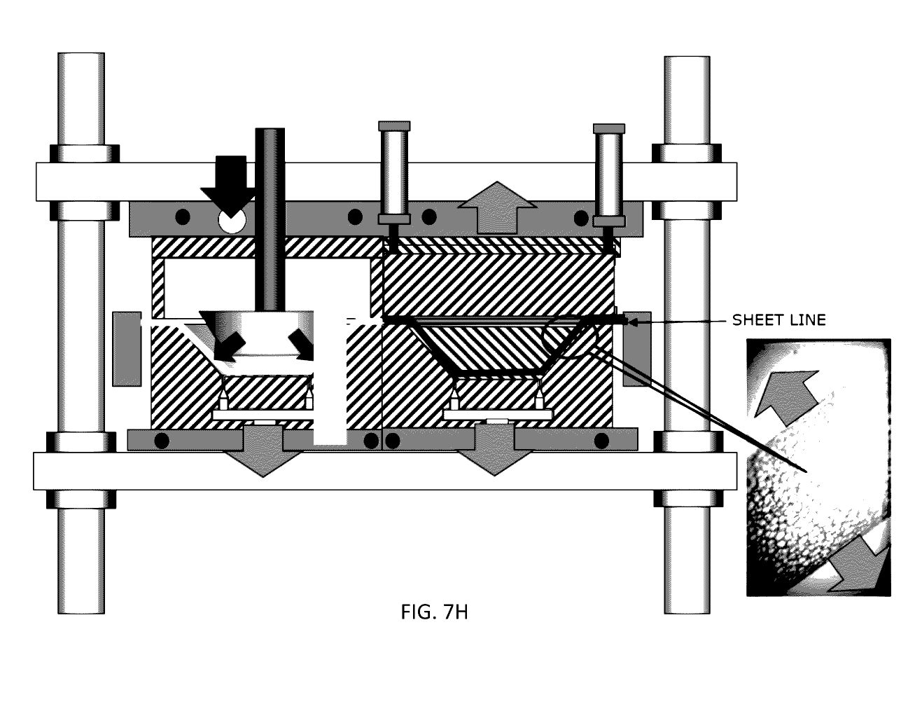

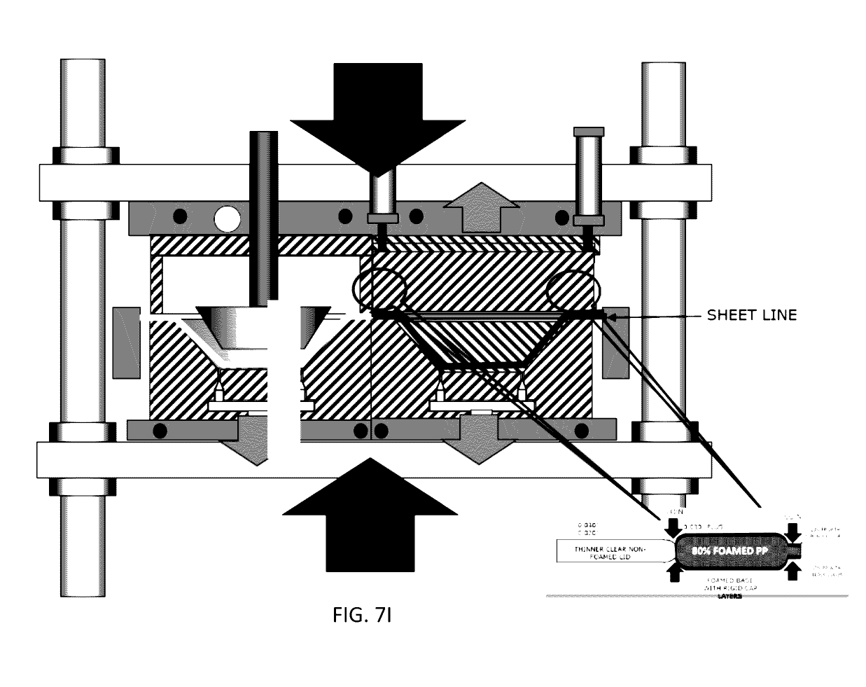

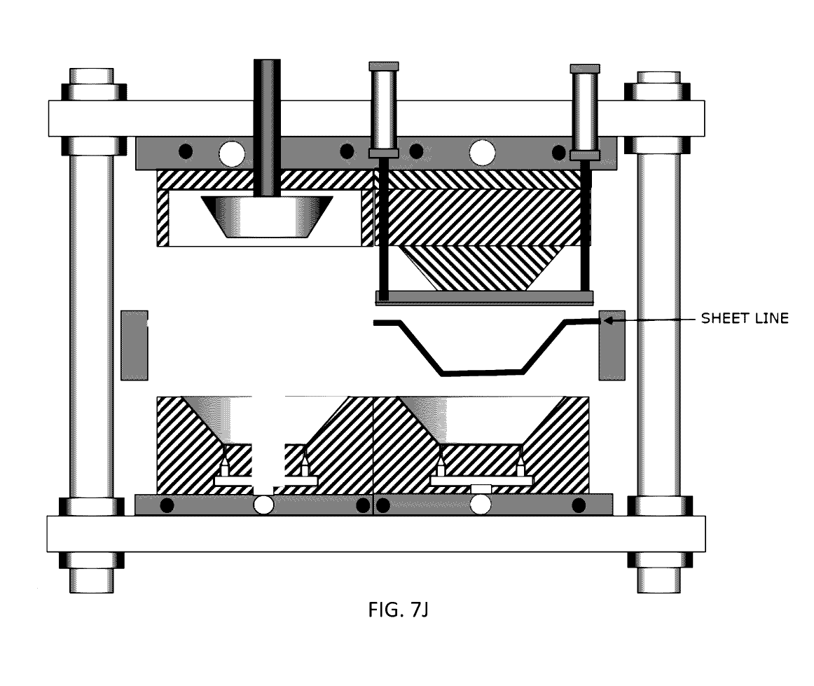

FIGS. 7A-7J are cross-sectional views of a thermoforming tool, generally designated by reference number 2000, during various stages of a thermoforming process according to an exemplary embodiment of the present invention. The thermoforming tool 2000 includes an upper form platen 2002, a lower form platen 2004, a plug assist element 2006 movably held within mold part 2007, a negative mold part 2008, a matched metal tool 2010 that includes a positive mold half 2012 and a negative mold half 2014, a form air pressure port 2016 associated with the plug assist element 2006, a vacuum port 2018 associated with the negative mold part 2008, a vacuum port 2020 associated with the positive mold half 2012 of the matched metal tool 2010, a vacuum port 2022 associated with the negative mold half 2014 of the matched metal tool 2010, a sheet clamp 2024 and a clamp actuator 2026. In operation, as shown in FIG. 7A, a heated thermoplastic film sheet 2050 is guided into the thermoforming tool 2000 by, for example, chain rails 2028. The sheet 2050 includes a clear and non-foamed side that is fed between the plug assist element 2006 and the negative mold part 2008 and an opaque and foamed side that is fed between the positive and negative mold halves 2012, 2014 of the matched metal tool 2010.

Then, as shown in FIG. 7B, the lower form platen 2004 is moved upwards so that the negative mold part 2008 and the negative mold half 2014 are in turn moved to the sheet line.

As shown in FIG. 7C, the upper form platen 2002 then moves the sheet clamp 2024 to the sheet line where the sheet clamp 2024 is activated by the clamp actuator 2026, resulting in the foamed side of the sheet 2050 being clamped firmly around the perimeter of each mold cavity formed by the positive and negative mold halves 2012, 2014.

As shown in FIG. 7D, the upper form platen 2002 continues to move the positive mold half 2012 into its respective mold cavity, causing the foamed side of the sheet 1050 to be pre-stretched into the cavity.

As shown in FIG. 7E, the upper form platen 2002 continues to move downwards until the mold part 2007 is closed tightly with the negative mold part 2008 and the positive mold half 2012 is closed tightly with the negative mold half 2014.

As shown in FIG. 7F, the plug assist element 2006 is then driven into the non-foamed side of the sheet 2050. In this regard, the plug assist element 2006 may be actuated at a preset speed and timing and to a preset depth.

As shown in FIG. 7G, the vacuum port 2018 is then turned on to pull the non-foamed portion of the sheet 2050 off the plug assist element 2006 and against the negative mold part 2008. The vacuum ports 2020 and 2022 are also turned on, which causes the foam cells in the foamed portion of the sheet 2050 to expand, which in turn results in the sheet thickness within the foamed portion to increase upon release of the mold halves 2012, 2014.

As shown in FIG. 7H, a high form air pressure is then introduced through the form air pressure port 2016 to force the non-foamed portion of the sheet 2050 against the cooled negative mold part 2008. This ensures superior definition of the formed part and also helps cool the part efficiently as the sheet 2050 is held intimately against the surface of the negative mold part 2008.

As shown in FIG. 7I, the mold halves 2012, 2014 are then squeezed very tightly together to coin the perimeter of the foamed portion of the film 2050 so that the foamed inner core of the sheet 2050 is encased in a rigid outer layer of plastic.

As shown in FIG. 7J, the vacuum and air pressure is then turned off and the thermoforming tool 2000 is opened for removal of the formed part. The formed part may then be moved to a trimming station for further processing.

While particular embodiments of the invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A lidded container comprising a base portion comprising foamed polypropylene and a lid portion connected to the base portion via a hinge wherein the base portion has a greater thickness than the lid portion.

2. The lidded container of claim 1 wherein the base portion comprises outer layers of unfoamed polypropylene and an inner layer of foamed polypropylene.

3. The lidded container of claim 1 wherein the base portion is opaque and at least part of the lid portion is transparent.

4. The lidded container of claim 2, wherein the outer layers of the base portion further comprise a pigment.

5. The lidded container of claim 4 wherein part of the lid portion is opaque.

6. A method of manufacturing the lidded container of claim 1 comprising the steps of:
co-extruding a film comprising a portion comprising foamed polypropylene and a portion comprising unfoamed polypropylene;
feeding the film to a thermoforming tool; and
forming the film into a container shape comprising a base portion comprising foamed polypropylene, a lid portion comprising unfoamed polypropylene and a hinge connecting the base portion and the lid portion.
